(19) United States
(12) Patent Application Publication
(10) Pub. No.: US 2025/0326419 A1
(43) Pub. Date: Oct. 23, 2025

(54) A LOAD MOVING APPARATUS

(71) Applicant: M-MOVER HOLDINGS LIMITED, Ashbourne, Derbyshire (GB)

(72) Inventors: Andrew OWEN, Ashbourne, Derbyshire (GB); James JONES, Ashbourne, Derbyshire (GB); Stephen ANTILL, Ashbourne, Derbyshire (GB); William HEALEY, Ashbourne, Derbyshire (GB)

(21) Appl. No.: 18/869,908

(22) PCT Filed: May 31, 2023
(86) PCT No.: PCT/GB2023/051434

§ 371 Date: Nov. 27, 2024

(30) Foreign Application Priority Data
Jun. 1, 2022 (GB) 2208095.6

(51) Int. Cl. B62B 5/00; B66F 5/02

(52) U.S. Cl. CPC B62B 5/0036; B66F 5/02

(57) ABSTRACT

A main body including a front portion and a rear portion; a ground engaging device configured for rotation about a substantially horizontal axis A; a drive member for driving the at least one ground engaging device; and a transmission member operably connected to the drive member and the ground engaging device for transmitting drive from the drive member to the ground engaging device for rotating the device about the axis A; wherein the axis A lies on a substantially vertical plane X, said plane X positioned between the front portion and the rear portion; and wherein the drive member is positioned in the rear portion of the main body.

### INTRODUCTION

Embodiments of the present invention relates to a load moving apparatus. More particularly, this invention relates to a load moving apparatus for use by a pedestrian.

### BACKGROUND

Load moving apparatus are used to assist a user with moving large or heavy goods. Such apparatus typically include a ground engaging wheel, or set of wheels, which may or may not be connected to a source of power. To move a load, such apparatus are typically configured to engage with a load such that the load may be pushed or pulled.

Embodiments of the present invention seek to alleviate one or more problems associated with the prior art.

### BRIEF DESCRIPTION OF THE INVENTION

According to a first aspect of the invention we provide a load moving apparatus including:
a main body including a front portion and a rear portion;
a ground engaging device configured for rotation about a substantially horizontal axis A;
a drive member for driving the at least one ground engaging device; and
a transmission member operably connected to the drive member and the ground engaging device for transmitting drive from the drive member to the ground engaging device for rotating the device about the axis A;
wherein the axis A lies on a substantially vertical plane X, said plane X positioned between the front portion and the rear portion; and
wherein the drive member is positioned in the rear portion of the main body.

The transmission member may be a gearbox.

The plane X may intersect the gearbox.

The gearbox may include a worm gear operably connected to the drive member.

The gearbox may include a gear operably connected to the worm gear and the ground engaging device.

The gearbox may be a right-angle gearbox.

The gear may be generally coaxial with the axis A.

The gearbox may be positioned generally forwardly of the drive member.

The gearbox may be positioned generally below the drive member.

The drive member may define a main axis B oriented substantially perpendicular to the horizontal axis A of the ground engaging device.

The axis B of the at least one drive member may be inclined at an angle relative to a ground surface, in use.

The main body may define a main axis M and wherein the axis B is generally parallel to the axis M.

The drive member may be, or may include, a motor; optionally an electric motor, e.g., a permanent magnet DC electric motor, brushless DC electric motor or AC electric motor.

The ground engaging device may be a wheel assembly.

The load moving apparatus may include a further ground engaging device, optionally wherein the ground engaging device may be positioned to a first side of the main body and the further ground engaging device may be positioned to a second, generally opposite, side of the main body.

The further ground engaging device may include one or more or all of the features of the ground engaging device as set forth above.

The load moving apparatus may include a further drive member drivingly connected to the further ground engaging device, optionally wherein the drive member may be positioned to a or the first side of the main body and the further drive member may be positioned to a or the second, generally opposite, side of the main body.

The further drive member may include one or more or all of the features of the drive member as set forth above.

The load moving apparatus may include a further transmission member operably connected to the further drive member and the further ground engaging device for transmitting drive from the further drive member to the further ground engaging device, optionally wherein the transmission member may positioned to a or the first side of the main body and the further transmission member may positioned to a or the second, generally opposite, side of the main body.

The further transmission member may include one or more or all the features of the transmission member as set forth above.

The load moving apparatus may further include a load engagement device for engagement with a load to be moved, the device supported on or by the main body.

The load engagement device may be supported on the front portion of the main body.

The load engagement device may be rotatably mounted to the main body, optionally rotatably mounted about a generally vertical axis C.

The load moving apparatus may include a weight member positioned within the front portion of the main body, optionally forwardly of the drive member and/or the transmission member.

The load moving apparatus may be generally symmetrical about a plane B which is orthogonal to the plane X and the axis A.

In use, the main body may be inclined at an angle to a surface.

The load moving apparatus may include a user graspable handle.

The main body may include first and second respective ends.

The first end may be positioned closer to a surface in use than the second end.

The ground engaging device may be positioned at the first end.

The user graspable handle may be positioned at the second end.

The load moving apparatus may include a castor wheel assembly.

The castor wheel assembly may be positioned rearwardly of the first end.

The castor wheel assembly may be positioned under the second end.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a perspective view of a load moving apparatus for use by a pedestrian in accordance with the present disclosure;

FIG. 2 is a side view of the load moving apparatus of FIG. 1;

FIG. 3 is a plan view of the load moving apparatus of FIG. 1;

FIG. 4 is a side view of the load moving apparatus of FIG. 1 with a housing, battery and wheel of the apparatus removed;

FIG. 5 is a bottom perspective view of the load moving apparatus of FIG. 1;

FIG. 6 is a bottom perspective view of the load moving apparatus of FIG. 1 with a wheel of the apparatus removed;

FIG. 7 is a rear view of the load moving apparatus of FIG. 1;

FIG. 8 is a rear view of the load moving apparatus of FIG. 1 with a wheel and castor wheel assembly of the apparatus removed;

FIG. 9 is a side view of the load moving apparatus of FIG. 1;

FIG. 10 is an enlarged side view of detail figure 10-10 of FIG. 9;

FIG. 11a is a plan view of the load moving apparatus of FIG. 1 with a load engagement device in a second or third position;

FIG. 11b is a plan view of the load moving apparatus of FIG. 1 with a load engagement device in a first position;

FIG. 11c is a plan view of the load moving apparatus of FIG. 1 with a load engagement device in a second or third position;

FIG. 12a is a front view of the load moving apparatus of FIG. 1 with a load engagement device in a second or third position;

FIG. 12b is a front view of the load moving apparatus of FIG. 1 with a load engagement device in a second or third position;

FIG. 13a is a perspective view of the load moving apparatus of FIG. 1 with a cover removed and a hydraulic pump provided on the main body;

FIG. 13b is a perspective view of the load moving apparatus of FIG. 1 with a cover removed and a cable-actuated actuator provided on the main body; and

FIG. 14 is a rear perspective view of the load moving apparatus of FIG. 1.

### DETAILED DESCRIPTION OF THE DISCLOSURE

Referring to the figures there is provided a load moving apparatus 10 in accordance with the present disclosure. The load moving apparatus 10 may be for use by a pedestrian, i.e., it is for use by a person not in a vehicle. The load moving apparatus 10 includes a main body 12, at least one ground engaging device 14, at least one drive member 16 and at least one transmission member 18. In embodiments, the apparatus 10 may also include at least one weight member 20, a load engagement device 30, a user graspable handle 40, a castor wheel assembly 50 and a power receptacle 60. These are described in more detail below.

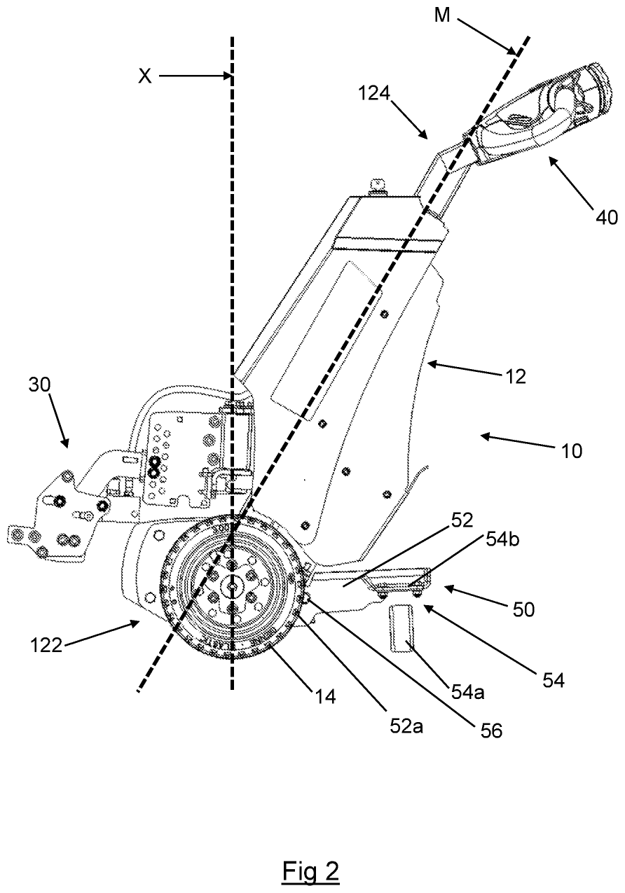

The main body 12 supports components of the apparatus 10. As shown in FIG. 2, the main body 12 may include a first end 122 and a second end 124. An axis M may extend between the first and second ends 122, 124. The axis M may be a main axis of the main body 12. In other words, the axis M may be positioned generally centrally of the main body 12.

The main body includes a front portion 12a and a rear portion 12b. In embodiments, the main body 12 is intersected by a substantially vertical plane X. As shown in FIG. 2, the vertical plane X may be intersected by the axis M. The vertical plane X is positioned between the front portion 12a of the main body 12, e.g., the front portion 12a may be located on one side of the plane X, and the rear portion 12b of the main body 12, e.g., the rear portion 12b may be located on the opposite side of the plane X relative to the front portion 12a.

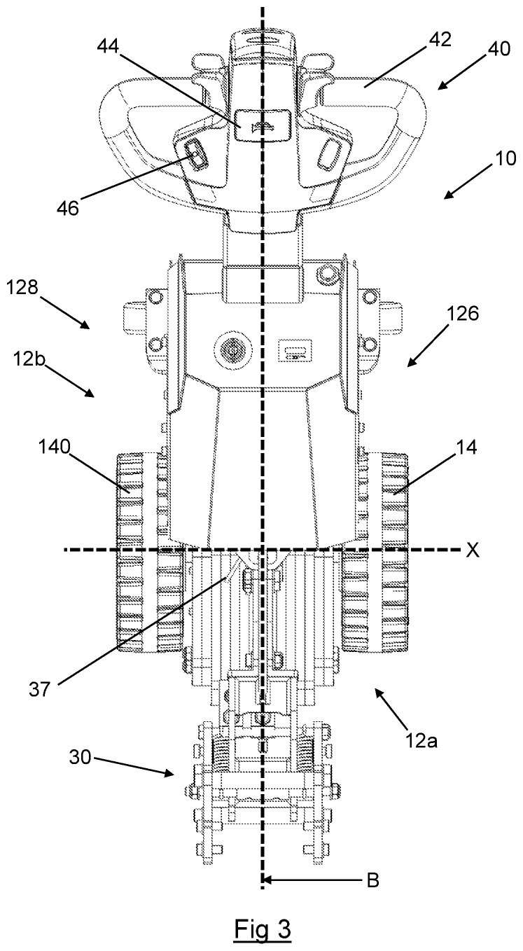

The main body may include a first lateral side 126 and a second lateral side 128. As shown in FIG. 3, the main body 12 may be intersected by a substantially vertical plane B which is generally perpendicular to the vertical plane X. The plane B may be positioned between the first side 126 of the main body 12 and a second side 128 of the main body 12 generally opposing the first side 126. In embodiments, the apparatus 10 and/or the main body 12 may be generally symmetrical about the plane B. The axis M of the main body 12 may lie on the plane B, as shown in FIG. 3, i.e., the axis M may be perpendicular to the plane X. In embodiments, the axis M is inclined relative to a surface (e.g., the ground) when the apparatus 10 is in use, as shown in FIG. 2. In particular, the axis M may extend downwardly through the plane X as it extends from the second end 124 towards the first end 122.

The main body 12 may be inclined relative to a surface (e.g., the ground) when the apparatus 10 is in use. In other words, the main body 12, in use, may extend in a direction away from a surface (e.g., the ground) and rearwardly of the plane X. The main body 12 may extend in a direction away from one or more or all of: the at least one ground engaging device 14; the at least one drive member 16; the at least one transmission member 18; the at least one weight member; the load engagement device 30; and the castor wheel assembly 50. The castor wheel assembly 50 may be positioned underneath the main body 12 and rearwardly of the ground engaging device 14, as described in more detail below. In embodiments, the axis M may be oriented substantially parallel to, or perpendicular to, a surface over which the apparatus 10 is resting upon or moving across when the apparatus 10 is in use.

In embodiments, the main body 12 may support or otherwise include a housing 13 which, in use, at least partially covers components of the apparatus 10. The housing 13 may be releasably attached to the main body 12 to allow access to the components of the apparatus 10 for the purposes of repair and servicing.

The ground engaging device 14 supports the main body 12 and assists in moving the main body 12 over a surface (e.g., the ground). In the present embodiment, the ground engaging device 14 is configured for rotation about an axis A. In use of the apparatus, the axis A is substantially horizontal, i.e., it may be substantially parallel with a surface over which the apparatus 10 is resting upon or moving across.

The ground engaging device 14 is operably connected to a transmission member 18. The transmission member 18 is also operably connected to a drive member 16. In use of the apparatus, the drive member 16 provides a source of drive power to the ground engaging device 14. The drive power provided by the drive member 16 is transmitted to the ground engaging device 14 by the transmission member 18.

In the present embodiment, the ground engaging device 14 is a wheel assembly. The wheel assembly includes a tyre mounted to a hub. The tyre of the wheel assembly may be manufactured from any suitable material. In one example, the tyre may be manufactured from a puncture-proof rubber material. In another example, the tyre may be manufactured from a rubber material that is non-marking when in contact with a surface. The tyre may also include a tread of any appropriate arrangement. The hub of the wheel assembly may be manufactured from any appropriate material, including a metal or a plastic. The selection of material may be based on the operational requirements of the apparatus 10. The hub of the wheel assembly is operably connected to a part of the transmission member 18. In embodiments, the hub is operably connected to a part of the transmission member 18 by the use of one or more fasteners. For example, the or each fastener may be a threaded bolt or other threaded fastener which passes through a corresponding hole in the hub, which subsequently engages with an appropriate formation provided on a part of the transmission member 18 or a corresponding threaded nut. Alternatively, the or each fastener may pass through a hole on a part of the transmission member 18 and engage with an appropriate formation provided on the hub or a corresponding threaded nut. A part of the transmission member 18 may include a formation which engages with a formation provided on the wheel hub. For example, this may comprise a spline or groove on a part of the transmission member which engages with a projection on the wheel assembly, or vice versa. The formations of the hub and transmission member 18 provide for rotation alignment between the two parts, whilst the axial alignment may be provided by a fastener or fasteners which secures the hub to the transmission member 18.

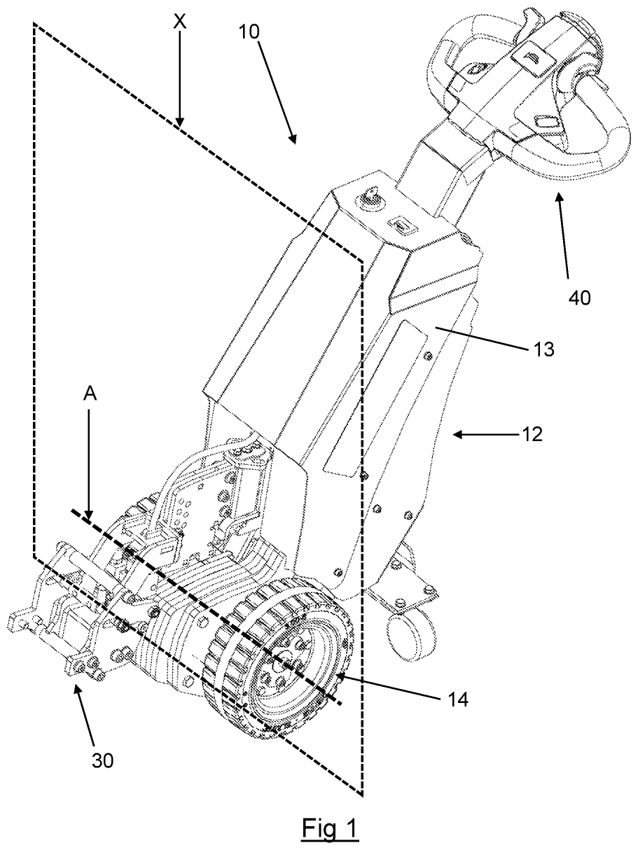

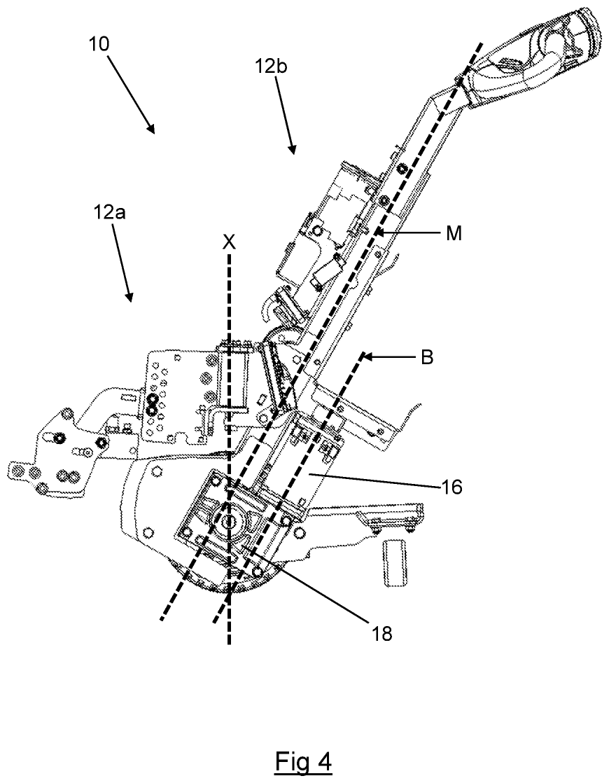

In the present embodiment, the transmission member 18 is a gearbox. In embodiments, other transmission members may be used, e.g., a pulley based or hydraulic system. The gearbox receives a rotational input from the drive member 16, and provides a rotational output which is transmitted to the ground engaging device 14. The gearbox may be arranged such that the rotational input and output are substantially aligned (i.e., the axes of rotation of the input and output are coincident), substantially parallel but offset by a non-specified distance, or substantially non-parallel such that an angle is formed between the rotational axes of the input and output. In embodiments, and as shown in FIGS. 1 and 4, the axis of the rotational input of the gearbox is substantially perpendicular to the axis of the rotational output of the gearbox. The gearbox 18 may be a right-angle gearbox comprising a worm gear which is operably connected to the drive member 16, and the worm gear engages with a gear which is operably connected to the ground engaging device 14 (i.e., via a shaft or axle). The gear which is operably connected to the ground engaging device 14 may be generally coaxial with the axis A of the ground engaging device 14. The gear which is operably connected to the ground engaging device 14 may be a spur gear, a helical gear, or any other appropriate form of gear. In other embodiments, the worm gear may be operably connected to the ground engaging device 14, and the gear may be operably connected to the drive member 16. In embodiments, the transmission member 18 is supported on or by the main body 12.

In the present embodiment, the drive member 16 is a motor. The motor may be an electric motor, and may be a permanent magnet DC electric motor, brushless DC electric motor, AC electric motor or any other appropriate type of electric motor. The drive member 16 extends in a generally lengthwise direction, defining a main axis B. A rotating part of the drive member 16, for example a rotating shaft, is operably connected to the transmission member 18, such that rotation produced by the drive member 16 is transmitted to the ground engaging device 14. Rotation transmitted to the ground engaging device 14 causes the ground engaging device 14 to rotate about the substantially horizontal axis A. The rotating part of the motor engages, or otherwise cooperates, with the worm gear of the transmission member 18. In embodiments, the rotating part of the motor may be aligned with the main axis B.

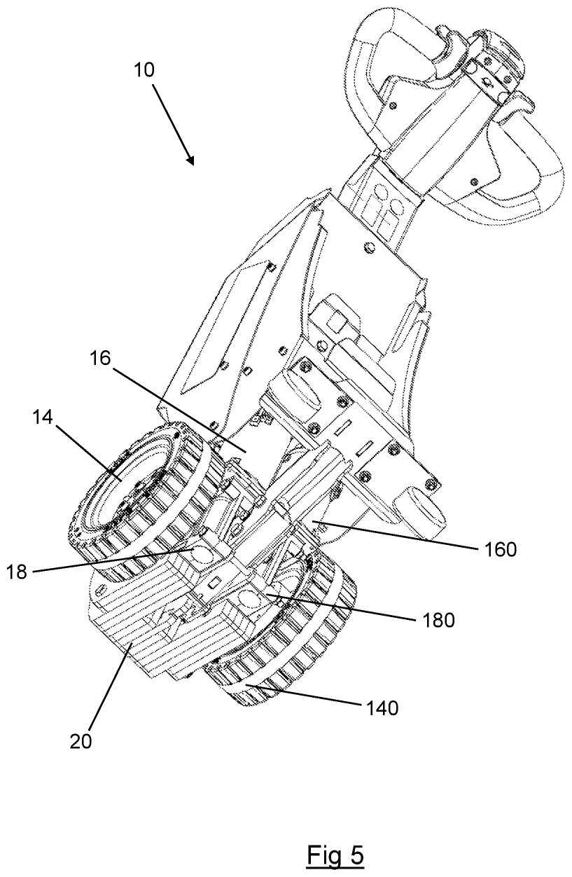

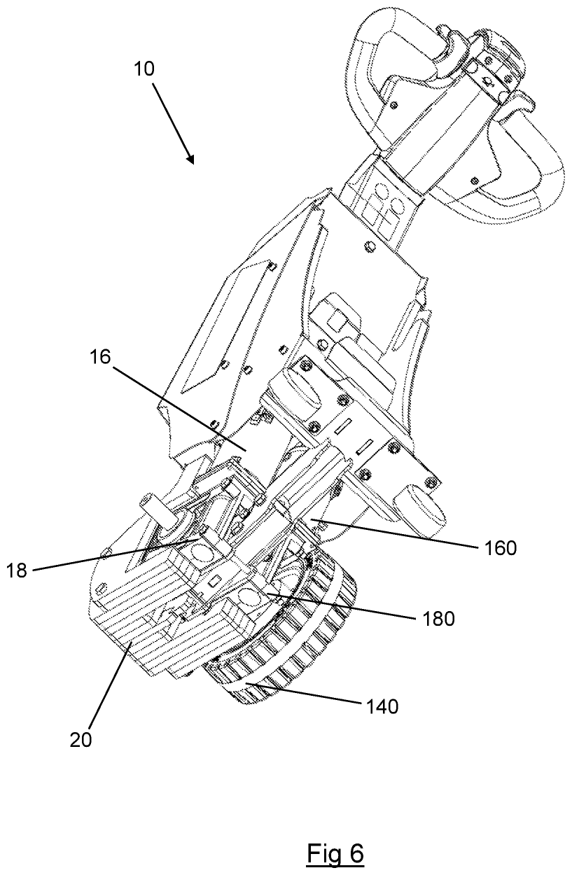

In the present embodiment, and as shown in FIGS. 5 and 6, the apparatus 10 includes a further ground engaging device 140 in addition to the ground engaging device 14. The ground engaging device 14 is positioned on the first side 126 of the main body 12 and the further ground engaging device 140 is positioned on the second side 128 of the main body 12. The further ground engaging device 140 may be substantially the same as the ground engaging device 14. In embodiments the further ground engaging device 140 may be different to the ground engaging device 14. In embodiments, the further ground engaging device 140 may be positioned generally opposite the ground engaging device 14. The further ground engaging device 140 may be positioned such that the ground engaging device and further ground engaging device rotate about a common or shared substantially horizontal axis A. In embodiments the ground engaging device and further ground engaging device may rotate about different axes.

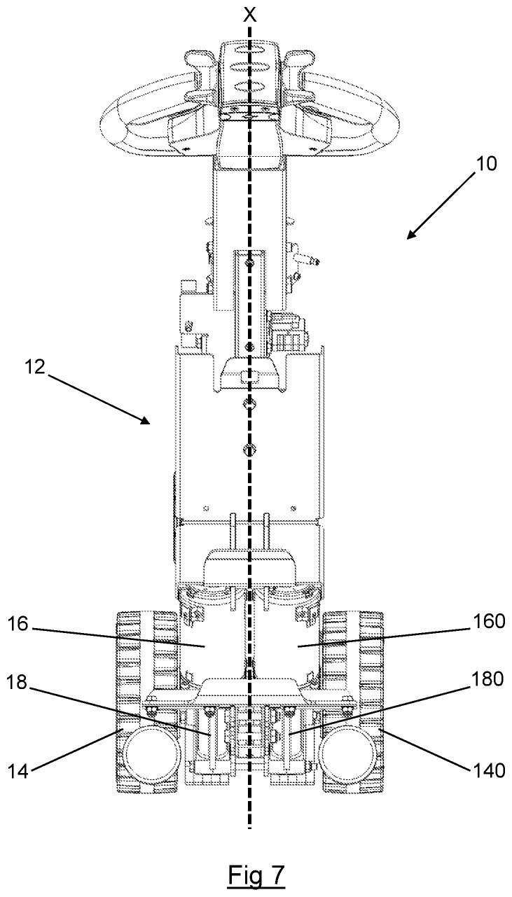

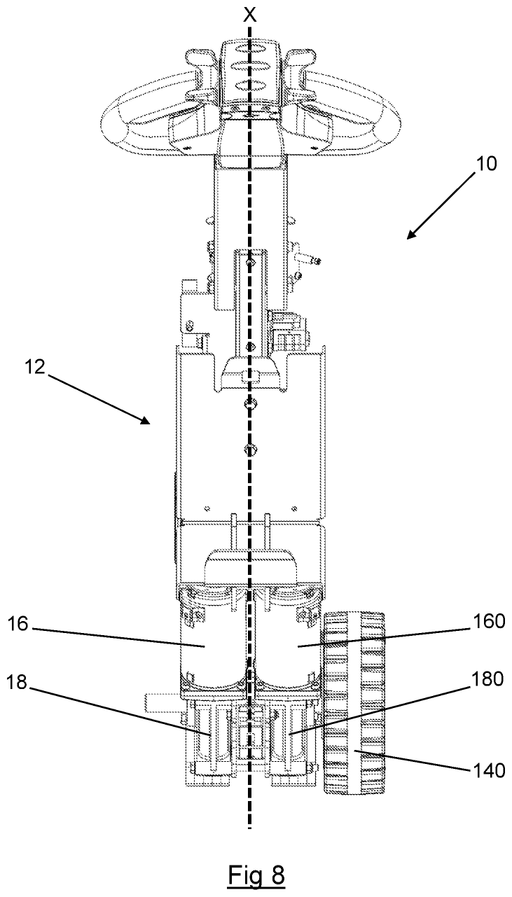

In the present embodiment, the apparatus also includes a further drive member 160 and a further transmission member 180, as shown in FIGS. 5 to 8. The further drive member 160 is operably connected to the further transmission member 180, and the further transmission member 180 is operably connected to the further ground engaging device 140. The operable connections may be similar, or substantially identical, to the operable connections between the drive member 16, transmission member 18 and ground engaging device 14 described above. In embodiments, the drive member 16 and transmission member 18 are positioned on the first side 126 of the main body 12, and the further drive member 160 and a further transmission member 180 are positioned on the second side 128 of the main body 12. In other embodiments, the apparatus 10 may not include a further drive member 160 and further transmission member 180. In embodiments the ground engaging device 14 and further ground engaging device 140 may be operably connected to a single transmission member 18 which is operably connected to a single driver member 16, such that the ground engaging device 14 and further ground engaging device 140 are driven by a single drive member 16.

With reference to FIGS. 1 to 8, the general layout of the apparatus 10 will be described now with reference to the ground engaging device 14, drive member 16 and transmission member 18. The layout of the further ground engaging device 140, further drive member 160 and further transmission member 180 may be substantially similar or identical to the layout described, and thus will not be described in detail. In the present embodiment, the ground engaging device 14 is positioned at, or adjacent to, the first end 122 of the main body 12. As shown in FIG. 1, the substantially horizontal axis A of the ground engaging device 14 lies on the substantially vertical plane X. The vertical plane X intersects the ground engaging device 14. The vertical plane X may intersect the transmission member 18, as shown in FIG. 4. In embodiments, the transmission member may be positioned in the rear portion 12b of the main body 12, e.g., rearwardly of the plane X. The drive member 16, which is operably connected to the transmission member 18 is positioned in the rear portion 12b of the main body 12. For example, the drive member 16 is not intersected by the plane X. In other words, the drive member 16 is positioned rearwardly of the axis A and/or the plane X. As shown in FIG. 4, the drive member 16 may be positioned such that the main axis B of the drive member 16 is oriented substantially perpendicular to the horizontal axis A of the ground engaging device 14. The axis B may be generally parallel to the axis M of the main body 12. The axis B may be inclined relative to a ground surface, in use. The ground engaging device 14 and the transmission member 18 are positioned generally forwardly of the drive member 16.

Advantageously, positioning the drive member 16 rearwardly of the axis A of the ground engaging device 14 and the plane X, such that it is positioned in the rear portion 12b of the main body 12 and not within the front portion 12 of the main body 12 enables the general shape and profile of the front portion 12a of the main body 12 to be provided such that much of the main body 12 is not positioned forwardly of the plane X. This means that the apparatus 10 may be able to cooperate with, and ultimately move, loads which are awkwardly shaped and/or have overhanging portions. Such a positioning of the drive member also enables a load engagement device 30 of the apparatus 10 advantageously to move between the first and second sides of the apparatus 10 through a 180 degree range of motion. This is described in more detail below.

In embodiments, the apparatus 10 may also include at least one weight member 20, as shown in the figures. The at least one weight member 20 may be supported on or by the main body 12. In use, the weight member 20 may be supported on the apparatus such that the weight member 20 increases the total mass of the apparatus 10. The position of a weight member 20 may serve to alter the location of the centre of mass of the apparatus 10, relative to an apparatus 10 which does not include a weight member 20. It is desirable, for optimum performance of the apparatus 10 in use, for the centre of mass of the apparatus 10 to be close to a ground surface, and to be close to the axis A of the ground engaging device 14. Positioning the drive member 16 in the rear portion 12b of the main body 12 advantageously provides more space within the front portion 12a of the main body for affixing a weight member 20 to the apparatus 10. As shown in the figures, the placement of a weight member 20 in the front portion 12a forwardly of the drive member 16 and transmission member 18 enables the weight member 20 to be placed close to the front end 122 of the main body 12 and close to the ground engaging device 14, bringing the centre of mass of the apparatus 10 both closer to the ground surface upon which the apparatus 10 is moving across and closer to the axis A of the ground engaging device 14, thereby increasing the tractive force between the ground engaging device 14 and a ground surface. In addition, close placement of the weight member 20 to a ground surface, by virtue of the placement of the drive member 16 in the rear portion 12b of the main body 12, reduces the possibility of the weight member 20 obstructing the apparatus 10 from engaging with a load to be moved.

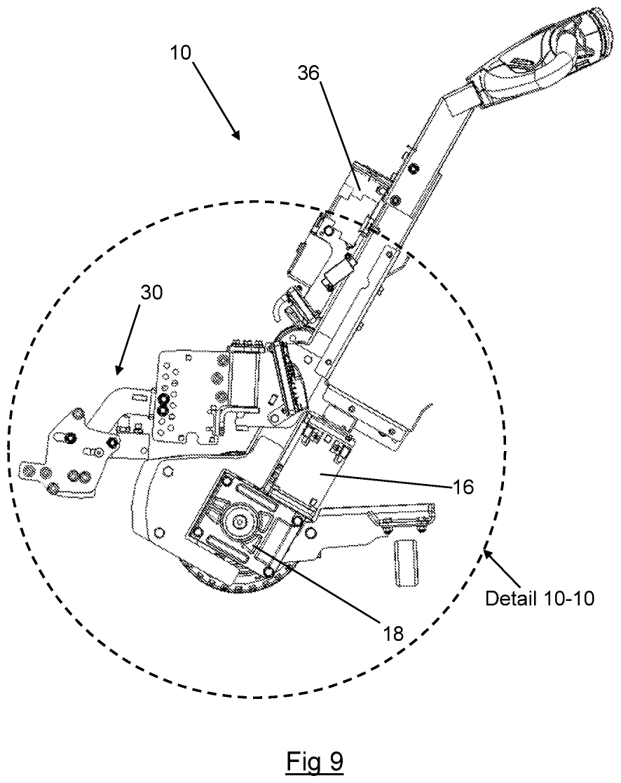

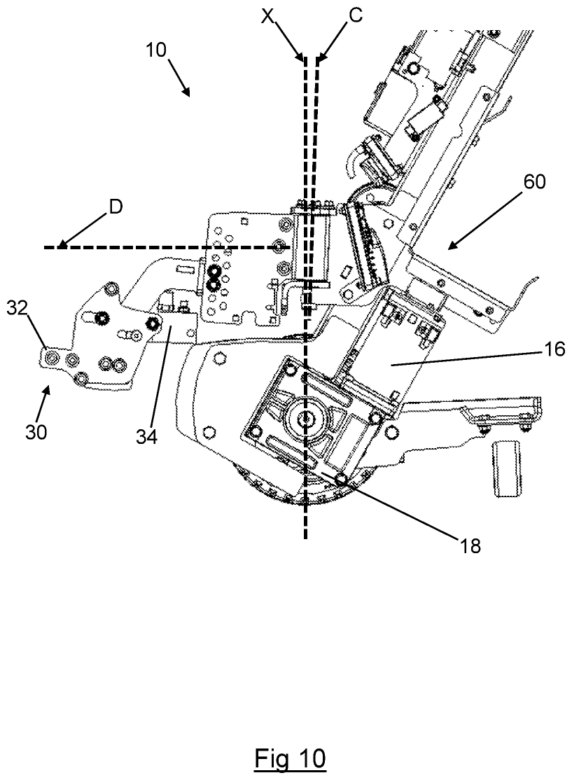

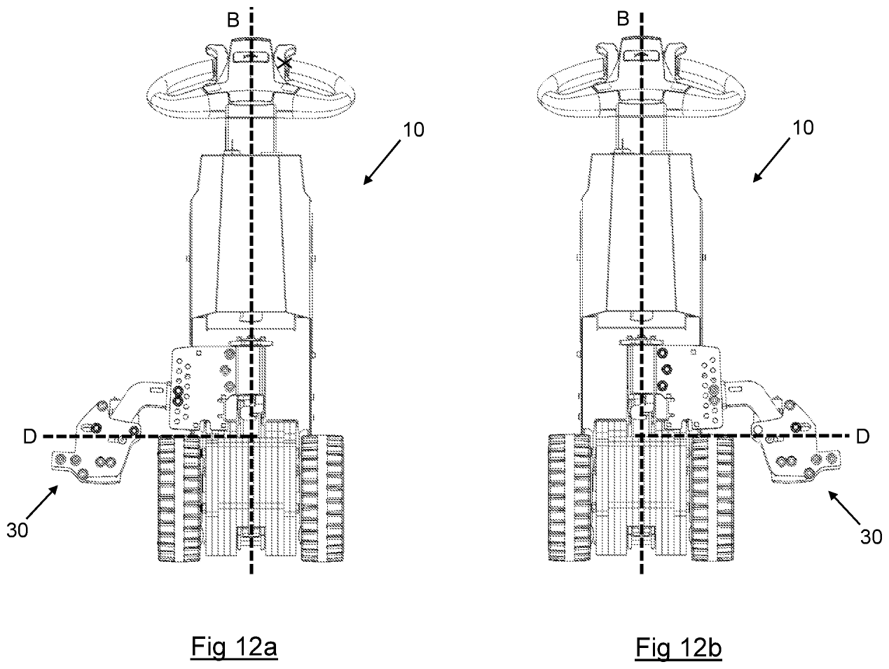

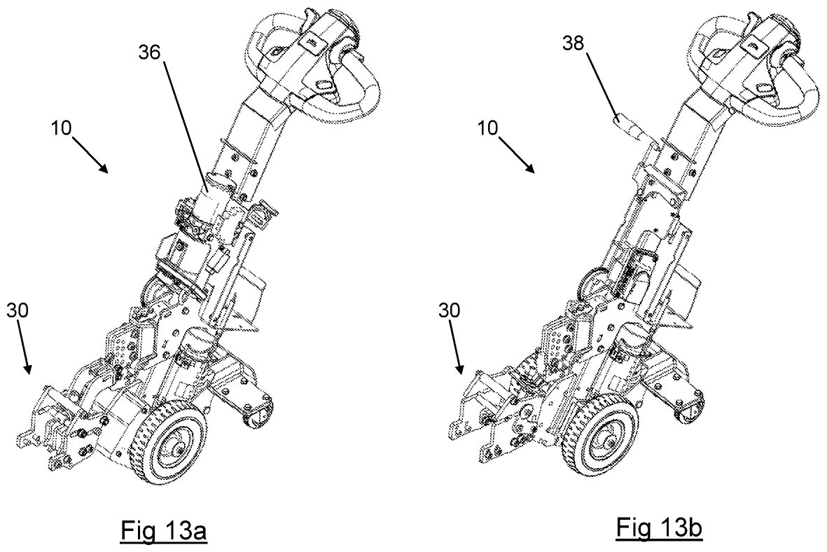

In embodiments, and with reference to FIGS. 9 to 12b in particular, the apparatus 10 may include a load engagement device 30. In use, the device 30 may abut with, engage with or grasp a part of a load to be moved. The load engagement device 30 may include at least one engagement member 32 which engages with or grasps a part of a load to be moved. The at least one engagement member 32 may be moveable between a first position in which the member 32 is engaged with a part of a load to be moved, and a second position in which the member 32 is disengaged from a part of a load to be moved. The at least one engagement member 32 may be operably connected to an actuation member 34, which effects the movement of the engagement member 32 between the first and second positions. The actuator member 34 may be an electrical actuator, or it may be a hydraulic actuator such as an electrohydraulic actuator, or it may be a cable-actuated actuator such as a Bowden cable type actuator. In embodiments, and as shown in FIGS. 13a-b, the source of hydraulic power for an electrohydraulic actuator, such as a pump 36 and/or an accumulator (not shown), or a cable mechanism 38, for example a Bowden cable mechanism, for a cable-actuated actuator may be supported on or by the main body 12. The load engagement device 30 is supported on or by the main body and is positioned in or adjacent to the front portion 12a of the main body 12.

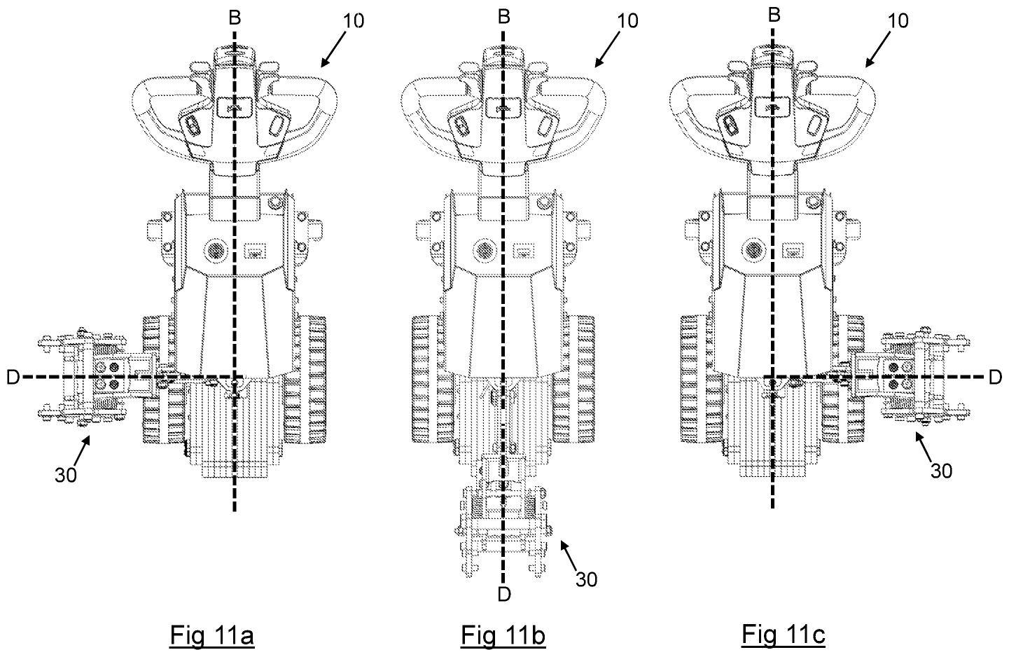

In embodiments, the load engagement device 30 is rotatably mounted to the main body 12, and is configured to rotate about an axis C. In embodiments, the axis C may be substantially parallel with the vertical plane X, may lie on the plane X, or may intersect the vertical plane X. The axis C may be positioned substantially perpendicular to, the axis A of the ground engaging device 14. As shown in FIGS. 9 to 12b, the load engagement device 30 may extend along an axis D, e.g., in a direction away from the main body 12. In particular, the axis D, in a ready to use condition of the apparatus 10, may lie on the plane B. The load engagement device 30 may be rotatably movable in a clockwise and anti-clockwise direction. The load engagement device 30 may be rotatable between a first position where the axis D is substantially perpendicular to the horizontal axis A of the ground engaging device 14 and/or the vertical plane X intersecting the main body 12, and a second position whereby the axis D is oriented at a non-perpendicular angle to the horizontal axis A. In the second position, the axis D may be parallel to, or coaxial with, the horizontal axis A. As shown in FIGS. 11a-c and 12a-b, the load engagement device 30 may thus be movable through 180 degrees of motion relative to the main body 12. In the second position the load engagement device 30 may be positioned on the first side 126 of the apparatus 10, and substantially adjacent the ground engaging device 14. The load engagement device 30 may then be rotated 180 degrees about the axis C to a third position, such that it is positioned on the second side 128, and substantially adjacent the further ground engaging device 140. The load engagement device 30 may also include a biasing member 37, which in use biases the load engagement 30 device towards the first position. The biasing member 37 may, in one example, be a torsion spring.

Advantageously, positioning the at least one drive member 14 in the rear portion of the main body 12 enables the load engagement device 30 to be mounted to the main body 12 such that it is generally positioned, in use, closer to a ground surface and closer to the at least one ground engaging device 14. Positioning of the load engagement device 30 closer to a ground surface enables the load engagement device 30 to engage with loads which are irregular in shape and may include overhanging portions. In addition, when the load engagement device 30 is mounted such that it is closer to a ground surface, the rearward positioning of the at least one drive member 14 ensures that the load engagement device 30 can rotate between the first and second positions and be moved through 180 degrees of rotational motion unimpeded, and will not make contact with any part of the apparatus 10. Furthermore, the rearward positioning of the at least one drive member 14 ensures that when the load engagement device 30 is positioned closer to a ground surface and ground engaging device 14, the axis C about which the load engagement device 30 rotates can be maintained directly above the axis A of the ground engaging device 14. Positioning of the axis C of the load engagement device 30 above the axis A of the ground engaging device ensures both optimal transfer of the weight of the load to be moved to the apparatus 10 and optimal steering performance of the apparatus 10 when it is engaged with a load to be moved.

The apparatus 10 can be operated by a pedestrian. In embodiments, the apparatus 10 may include a user graspable handle 40, which allows a pedestrian to operate the apparatus 10 for the purposes of movement and steering over a ground surface in addition to other functions such as operating other parts of the apparatus 10. The user graspable handle 40 is supported on or by the main body 12, and is connected towards the second end 124 of the main body 12 and positioned in or adjacent to the rear portion 12b of the main body 12. The user graspable handle 40 is positioned generally above the at least one ground engaging device 14, the at least one drive member 16, the at least one transmission member 18 and the load engaging device 30. The user graspable handle 40 may be formed of a material which is similar or dissimilar to the material of the main body 12, which may comprise a plastic and/or metal material. The user graspable handle 40 may be connected to the main body 12 by the use of a fastener or fasteners, may engage with a formation provided on the main body 12, may be permanently fixed to the main body 12, or may be formed integrally with a part of the main body 12. The user graspable handle 40 includes at least one user graspable part 42 at an upper free end, a portion of which may comprise a material which is comfortable for an operator to grasp, such as a rubber material, soft plastic material, or any other suitable material.

The apparatus 10 may include at least one alerting device 44, which may be operable by the operator. The at least one alerting device 44 may be positioned on the user graspable handle 40. The at least one alerting device 44 may be configured to produce an audible warning signal and/or a visual signal.

The apparatus 10 may include an operating device 46, which allows the operator to control a function of the apparatus 10, such as operation of the load engagement device 30 or any other appropriate function. The operating device 46 may be positioned on the user graspable handle 40.

In embodiments, the load moving apparatus 10 may be configured to be controlled from a remote device such that a pedestrian operator may be spaced at a distance from the apparatus 10 to move or otherwise operate the apparatus. In such embodiments, the apparatus 10 may include a user graspable handle 40 such that the operator may operate the apparatus 10 manually or remotely as desired.

In embodiments, the apparatus 10 may include a castor wheel assembly 50. The castor wheel assembly is positioned in or adjacent to the rear portion 12b of the main body 12. The castor wheel assembly 50 includes a castor arm 52 and at least one castor 54 which is connected to the castor arm. The castor arm 52 is connected at a first end 52a to the main body 12, and may be rotatably connected to the main body 12 such that it is rotatably moveable with respect to the main body 12 between a first and second position. In embodiments, the castor arm 52 may be connected to the main body 12 such that it remains in a fixed position. The at least one castor 54 includes a wheel portion 54a which is supported by, and is rotatably moveable relative to, a mounting portion 54b. The at least one castor 54 is mounted at or close to a second end 52b of the castor arm 52 via the mounting portion 54b. The at least one castor 54 may be configured such that, in use, the mounting portion 54b is able to swivel about a substantially vertical axis whilst permitting the wheel portion 54a to rotate. In embodiments, the castor wheel assembly 50 may also include a castor arm biasing member 56 which, in use, urges the castor arm 52 towards the first or second position. The castor arm biasing member 56 is connected at one end to a part of the castor arm 52 and is connected to a part of the main body 12 at another end. The castor arm biasing member 56 may comprise a coil spring or any other suitable biasing mechanism.

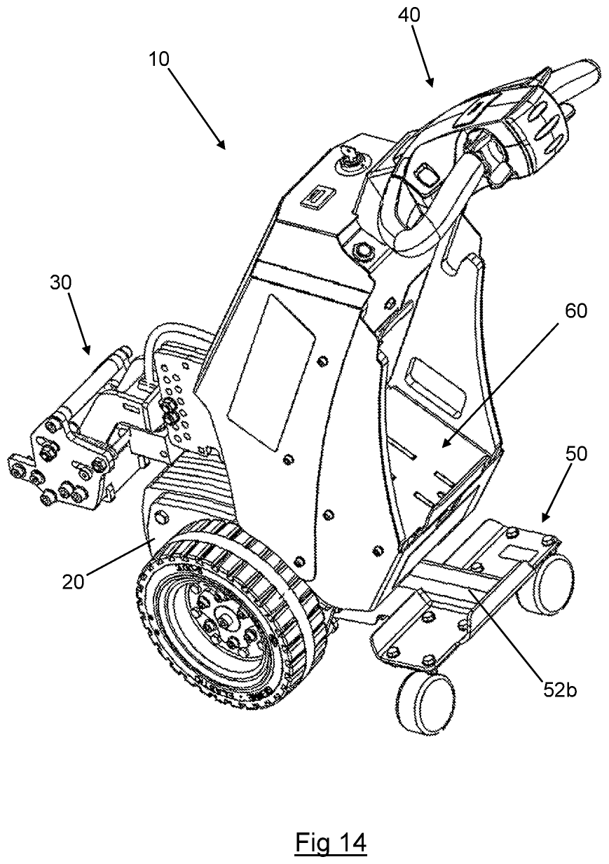

In embodiments, the apparatus 10 includes a power receptacle 60, as shown in FIG. 14. In some embodiments, the power receptacle 60 may be a socket or port which may receive a cable from an external power source, such as a source of mains electricity or a generator. In embodiments, the power receptacle 60 may be configured to receive an insertable battery. The battery received by the receptacle 60 may be a rechargeable battery, and may be a lead acid battery, a nickel metal hydride battery, a lithium-ion battery or a nickel cadmium battery. In use, the power receptacle is operably connected to the at least one drive member 16, and may be operably connected to other components of the apparatus 10, such as devices provided on the user graspable handle 40, which require a source of power to operate. In embodiments wherein a battery is received by the power receptacle 60, the operating characteristics of the battery, such as capacity, voltage, power, energy density and type may be selected based on the requirements of the apparatus 10.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

What is claimed is:

1.-25. (canceled)

26. A load moving apparatus including:
a main body including a front portion and a rear portion;
a ground engaging device configured for rotation about a substantially horizontal axis A;
a drive member for driving the at least one ground engaging device; and
a transmission member operably connected to the drive member and the ground engaging device for transmitting drive from the drive member to the ground engaging device for rotating the device about the axis A;
wherein the axis A lies on a substantially vertical plane X, said plane X positioned between the front portion and the rear portion; and
wherein the drive member is positioned in the rear portion of the main body.

27. The load moving apparatus of claim 26, wherein the transmission member is a gearbox.

28. The load moving apparatus of claim 27, wherein the plane X intersects the gearbox.

29. The load moving apparatus of claim 27, wherein the gearbox includes a worm gear operably connected to the drive member.

30. The load moving apparatus of claim 29, wherein the gearbox includes a gear operably connected to the worm gear and the ground engaging device.

31. The load moving apparatus of claim 30, wherein the gearbox is a right-angle gearbox; and/or
wherein the gear is generally coaxial with the axis A; and/or
wherein the gearbox is positioned generally forwardly of the drive member; and/or
wherein the gearbox is positioned generally below the drive member.

32. The load moving apparatus of claim 26, wherein the drive member defines a main axis B oriented substantially perpendicular to the horizontal axis A of the ground engaging device.

33. The load moving apparatus of claim 32, wherein the axis B of the at least one drive member is inclined at an angle relative to a ground surface, in use.

34. The load moving apparatus of claim 33, wherein the main body defines a main axis M and wherein the axis B is generally parallel to the axis M.

35. The load moving apparatus of claim 26, wherein the drive member is or includes a motor; wherein the motor is an electric motor, and the electric motor is one of a permanent magnet DC electric motor, brushless DC electric motor or AC electric motor.

36. The load moving apparatus of claim 26, wherein the ground engaging device is a wheel assembly.

37. The load moving apparatus of claim 26, including a further ground engaging device, wherein the ground engaging device is positioned to a first side of the main body and the further ground engaging device is positioned to a second, generally opposite, side of the main body.

38. The load moving apparatus of claim 37, wherein the further ground engaging device is configured for rotation about the substantially horizontal axis A, the drive member is configured to drive the further ground engaging device, and the transmission member is operably connected to the further ground engaging device for transmitting drive from the drive member to the further ground engaging device for rotating the further ground engaging device about the axis A.

39. The load moving apparatus of claim 37 including a further drive member drivingly connected to the further ground engaging device, wherein the drive member is positioned to the first side of the main body and the further drive member is positioned to the second, generally opposite, side of the main body.

40. The load moving apparatus of claim 39, wherein the further drive member defines a main axis B oriented substantially perpendicular to the horizontal axis A of the ground engaging device.

41. The load moving apparatus of claim 39 including a further transmission member operably connected to the further drive member and the further ground engaging device for transmitting drive from the further drive member to the further ground engaging device, wherein the transmission member is positioned to the first side of the main body and the further transmission member is positioned to the second, generally opposite, side of the main body; wherein the further transmission member is a gearbox.

42. The load moving apparatus of claim 26 further including a load engagement device for engagement with a load to be moved, the device supported on or by the main body;
wherein the load engagement device is supported on the front portion of the main body; and/or
wherein the load engagement device is rotatably mounted to the main body and is rotatably mounted about a generally vertical axis C.

43. The load moving apparatus of claim 26 including a weight member positioned within the front portion of the main body and positioned forwardly of the drive member and/or the transmission member; and/or
wherein the apparatus is generally symmetrical about a plane B which is orthogonal to the plane X and the axis A; and/or
wherein in use, the main body is inclined at an angle to a surface.

44. The load moving apparatus of claim 26 including a user graspable handle.

45. The load moving apparatus of claim 44, wherein the main body includes first and second respective ends, the first end being positioned closer to a surface in use than the second end;
wherein the ground engaging device is positioned at the first end;
wherein the user graspable handle is positioned at the second end;
wherein the loading moving apparatus further comprises a castor wheel assembly; and
wherein the castor wheel assembly is positioned rearwardly of the first end and under the second end.
